(19) United States
(12) Patent Application Publication
(10) Pub. No.: US 2026/0269396 A1
(43) Pub. Date: Sep. 10, 2026

(54) MOTOR VEHICLE TRACTION BATTERY PROVIDED WITH A VALVE PROTECTION COVER

(71) Applicants: AMPERE SAS, Boulogne-Billancourt (FR); NISSAN MOTOR CO., LTD, Kanagawa (JP)

(72) Inventors: Ion GHINEA, Bucarest (RO); Mihaela-Simona POPESCU, Bucarest (RO)

(73) Assignees: AMPERE SAS, Boulogne-Billancourt (FR); NISSAN MOTOR CO., LTD, Kanagawa (JP)

(21) Appl. No.: 19/166,975

(22) PCT Filed: Mar. 20, 2024
(86) PCT No.: PCT/EP2024/057497

§ 371 Date: Sep. 19, 2025

(30) Foreign Application Priority Data
Mar. 21, 2023 (FR) 2302650

(51) Int. Cl. H01M 50/24; H01M 50/249; H01M 50/262; H01M 50/278

(52) U.S. Cl. CPC H01M 50/24; H01M 50/249; H01M 50/262; H01M 50/278; H01M 2220/20

(57) ABSTRACT

The invention relates to a motor vehicle traction battery (20) comprising:—a tray (22) containing battery cells;—at least one valve (38, 40) arranged in a vertical wall (30) of the tray (22);—and a protective cover (54) secured against an outer face (58) of the vertical wall (30) and covering the at least one valve (38, 40); characterised in that the cover (54) comprises at least one lower rim (62) having a free end edge (63) in contact with the outer face (58) of the vertical wall (30) and intended to intercept a jet of water directed toward the at least one valve (38, 40), the lower rim (62) comprising water drainage openings (65).

### TECHNICAL FIELD OF THE INVENTION

The invention relates to a motor vehicle traction battery comprising:
a tray containing battery cells;
at least one valve arranged in a vertical wall of the tray;
a protective cover secured against an outer face of said vertical wall, covering said at least one valve.

### TECHNICAL BACKGROUND

The motor vehicles propelled by an electric motor, such as hybrid vehicles or electric vehicles, comprise a traction battery which is dimensioned to supply the electric traction motor.

Such a motor vehicle is equipped with a traction battery which is arranged under the chassis of the vehicle. For example, the traction battery is suspended inside a housing open at the bottom of the vehicle structure, with small lateral clearances, so that the lower face of the battery pack forms an underside of the vehicle. This makes it easier to fit and remove the battery packs.

According to another known design, the traction battery is suspended from rigid elements of the chassis, such as a structural crosspiece, by direct attachment to the battery tray. The chassis then comprise no housing.

Such a traction battery comprises battery cells which are enclosed in a tray. The tray is sealed to prevent substances harmful to the batteries from entering the tray.

When the traction battery is used, the battery cells emit volatile substances which gradually accumulate in the tray. This causes a gradual increase in pressure inside the tray. If the pressure becomes too high, there is a risk of damaging or even exploding the traction battery.

To avoid this problem, the battery tray is generally fitted with safety valves, often referred to by their acronym “PRV” meaning “Pressure Relief Valve”, which open under the effect of the internal pressure in the tray to open an orifice allowing volatile substances to escape to the outside of the tray.

The traction battery advantageously comprises two safety valves, for example a first valve called “PRD” meaning “Pressure Release Device” and a second valve produced by the company “NITTO”. A first valve opens under the effect of heat and a second valve opens under the effect of internal pressure.

The valves are arranged in a vertical wall of the battery. In order to function effectively, the valves open into a free space between the battery and adjacent components. This free space opens directly underneath the vehicle. The valves are therefore freely accessible from underneath the vehicle. The valves are therefore exposed to spray when the vehicle is moving, particularly from liquids. This is not generally a problem, as the valves comprise an annular seal, in particular a lip seal, which ensures that the orifice they close off is sealed when they are closed.

It is also known to use a high-pressure cleaning device propelling high-pressure jets of water for cleaning motor vehicles. For example, the water is compressed to between 80 and 150 bar before being emitted as a jet.

The valves of the traction battery exposed in this way are at risk of being hit by a high-pressure water jet. In general, a valve flap covers the seals, protecting them when the water jet is emitted perpendicular to the wall carrying the valves.

However, it was found that when a high pressure water jet is emitted in an inclined direction with respect to a direction orthogonal to the wall comprising the valves, it is likely to directly reach the valve seal. In this case, the pressure of the water jet is sufficient to deform the seal and allow water to penetrate inside the traction battery. This could damage the battery cells in the tray.

It is already known from the document FR-2.987.807-A1 to arrange a horizontal fairing under the vehicle chassis in order to improve the aerodynamics of the vehicle by closing all the gaps present around the battery. Such a fairing extends as an extension of a lower face of the tray of the traction battery. This type of fairing encloses the battery and prevents high-pressure water jets from reaching the valves.

However, such a fairing is formed by a bulky part of complex shape which is expensive to manufacture and install on the vehicle. Such a solution is therefore very expensive.

The fairing must always be fitted and removed when the battery is already mounted under the chassis.

There is therefore a need to prevent water from entering the battery through the valves effectively and at a lower cost.

### SUMMARY OF THE INVENTION

The invention relates to a motor vehicle traction battery comprising:
a tray containing battery cells;
at least one valve arranged in a vertical wall of the tray;
a protective cover which is secured to an outer face of said vertical wall, covering said at least one valve;
characterized in that the cover comprises at least one lower rim, a free end edge of which is in contact with the outer face of the vertical wall and which is intended to intercept a water jet directed towards said at least one valve, the lower rim comprising water discharge orifices.

According to another characteristic of the invention, the cover comprises an inner face equipped with at least one deflector which is interposed between the discharge orifices and said at least one valve, the deflector being intended to intercept a water jet passing through the discharge orifices and directed towards said at least one valve.

According to another characteristic of the invention, the deflector is formed by a rib which extends from the inner face of the cover in the direction of the vertical wall of the tray.

According to another characteristic of the invention, said vertical wall comprises two valves, said cover simultaneously covering the two valves, for example the “PRD” valve and the “NITTO” valve.

According to another characteristic of the invention, at least one deflector is interposed between the discharge orifices and each of the two valves.

According to another characteristic of the invention, the cover comprises a single deflector which is interposed between the discharge orifices and each of the two valves. This deflector allows, in particular, to prevent the penetration of a water jet under pressure towards the valves.

Another characteristic of the invention is that the cover is made of a plastic material.

Another characteristic of the invention is that the cover is made in a single piece by moulding. The cover is made of plastic, for example.

According to another characteristic of the invention, the vertical wall is made of an outer envelope comprising the outer face and an inner partition separated by an air gap, the cover being secured to the vertical wall by means of a nut secured in the outer envelope and a threaded rod which penetrates into the air gap without passing through the inner partition.

According to another characteristic of the invention, the vertical wall of the tray is equipped with two vertical bearing faces facing each other and projecting orthogonally with respect to the vertical wall, between which the cover is received, the cover comprising an elastically flexible free end tab enabling the cover to be held between the two bearing faces by clamping. This characteristic enables the cover to be held in position while it is being secured by an operator, while taking into account the manufacturing tolerances of the pieces.

### BRIEF DESCRIPTION OF THE FIGURES

Other characteristics and advantages of the invention will become apparent from the following detailed description, for the understanding of which reference is made to the appended figures.

FIG. 1 is a rear view schematically representing a vehicle chassis fitted with wheels and on which a traction battery has been mounted.

FIG. 2 is a perspective view of a traction battery which can be mounted on the vehicle of FIG. 1, the battery being able to be equipped with a cover produced in accordance with the teachings of the invention.

FIG. 3 is a sectional view along sectional plane 3-3 of FIG. 4 showing valves fitted to a rear vertical wall of the traction battery.

FIG. 4 is a schematic side view showing a traction battery produced according to the teachings of the invention mounted on the vehicle of FIG. 1.

FIG. 5 is a vertical longitudinal section perspective view showing the vertical rear wall of the battery fitted with its protection cover of the valves.

FIG. 6 is a sectional view along sectional plane 6-6 of FIG. 4 which shows an inner face of the cover produced in accordance with the teachings of the invention and the valves which it protects.

FIG. 7 is a front view of the rear vertical wall of the traction battery fitted with the cover in accordance with the teachings of the invention.

FIG. 8 is a sectional view along sectional plane 8-8 of FIG. 7 showing a attachment means for screwing the cover to the rear vertical wall of the traction battery.

### DETAILED DESCRIPTION OF THE INVENTION

In the remainder of the description, elements with an identical structure or similar functions will be designated by the same reference.

In the remainder of the description, we will adopt, by way of non-limitation:
longitudinal “L” directed in the direction of travel of the vehicle and oriented from the front towards the rear of the vehicle;
vertical “V” directed orthogonally to the road on which the vehicle is travelling and oriented from the bottom, close to the road, to the top;
transversal “T” directed orthogonally to the longitudinal and vertical directions, and oriented from left to right.

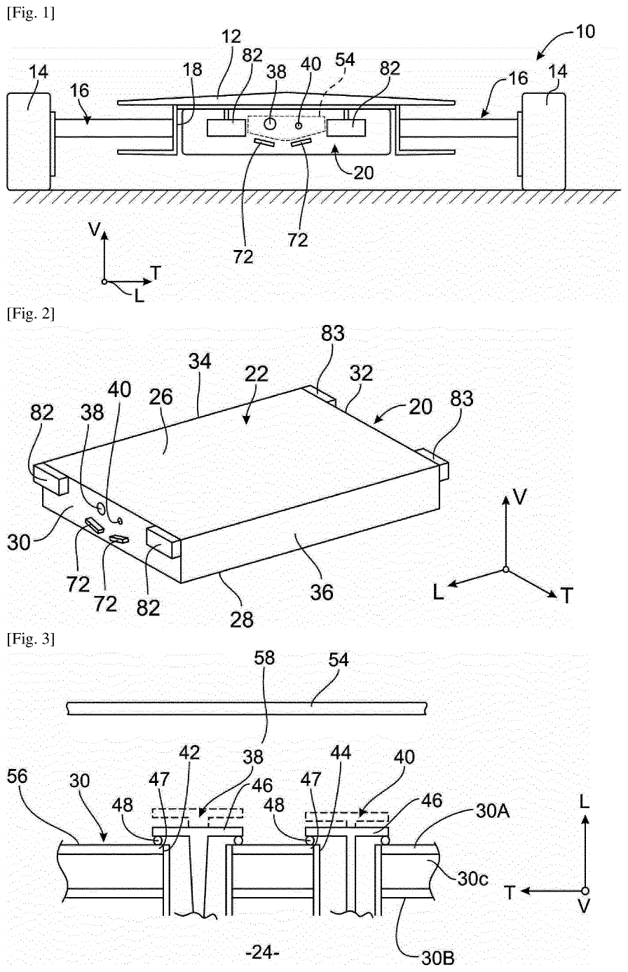

A schematic representation of a motor vehicle 10 seen from the rear is shown in FIG. 1. This is a vehicle 10 comprising at least one electric traction motor (not shown), such as an electric vehicle or a hybrid vehicle also comprising an internal combustion engine.

The vehicle 10 comprises a chassis 12 connected to four wheels 14, two of which are visible in FIG. 1, by means of an articulated suspension device 16.

The chassis 12 extends generally horizontally. It comprises a crosspiece 18. A traction battery 20 of the vehicle for powering the electric traction motor, which is designed to be secured under the crosspiece 18 by means of protuberances 82. The protrusions 83 of the traction battery 20 are secured directly to the chassis.

As shown in FIG. 2, the traction battery 20 comprises a tray 22. The tray 22 is generally in the form of a parallelepiped, enclosing in a sealed manner an inner space 24 containing battery cells (not shown). This inner space 24 is delimited by an upper horizontal wall 26, a lower horizontal wall 28, a rear vertical wall 30, a front vertical wall 32, a left lateral vertical wall 34 and a right lateral vertical wall 36.

The walls of the tray 22 are, for example, made of a metallic material, such as aluminium.

As explained in the preamble, the traction battery 20 comprises at least one valve 38, 40 which is arranged in an associated orifice 42, 44 which passes through one of the vertical walls of the tray 22, as illustrated in FIG. 3. This at least one valve 38, 40 allows the space 24 inside the tray 22 to communicate with the outside.

By way of a non-limiting example, said at least one valve 38, 40 is arranged in the rear vertical wall 30 of the tray 22.

By way of a non-limiting example, the tray 22 comprises two valves 38, 40 which are arranged close to each other in the same vertical wall 30. The two valves 38, 40 are arranged at approximately the same height on the rear vertical wall 30.

Each valve 38, 40 comprises a flap 46 that is mounted so as to move between a closed position in which it is bearing against a seat 47 of the associated vertical wall 30, as shown in solid lines in FIG. 3, and an open position in which it is lifted outwardly from its seat to open the associated orifice 42, 44, as shown by the broken lines in FIG. 3. An annular seal 48 is interposed between the seat 47 and the flap 46 to enable the associated orifice 42, 44 to be sealed when the flap 46 is in its closed position. This is a seal 48 made of elastomer material.

As shown in FIG. 4, the rear wall 30 of the tray 22 of the traction battery 20 is generally arranged at a distance from the adjacent components 50 of the vehicle, so that a free gap 52 is reserved between the adjacent component 50 and the rear wall 30. This free gap 52 opens out towards the bottom of the vehicle. As a result, when the vehicle is cleaned using a high-pressure cleaning device, the rear wall 30, and more particularly the valves 38, 40, are exposed to the high-pressure water jet.

It has been found that when a high-pressure water jet is directed towards the seal 48 of the valves 38, 40 along a direction “F” inclined with respect to a direction orthogonal to the associated vertical wall 30, here inclined with respect to a longitudinal direction, the water jet elastically deforms the seal 48. The seal 48 can then no longer fulfil its sealing function, allowing water to penetrate into the space 24 inside the tray 22.

To solve this problem, the invention proposes to arrange a protective cover 54 which is secured against an outer face 56 of said vertical wall 30 of the tray 22, covering said at least one valve 38, 40.

The cover 54 is only secured to the tray 22. In addition, the cover 54 is in contact only with the tray 22. This means that the cover 54 can be mounted on the tray 22 before the traction battery 20, thus equipped with its cover 54, is mounted under the chassis 12.

In particular, the cover 54 is secured only to the rear vertical wall 30 of the tray 22.

The cover 54 covers both valves 38, 40 simultaneously.

In a variant of the invention not shown, each valve 38, 40 is protected by such an individual cover.

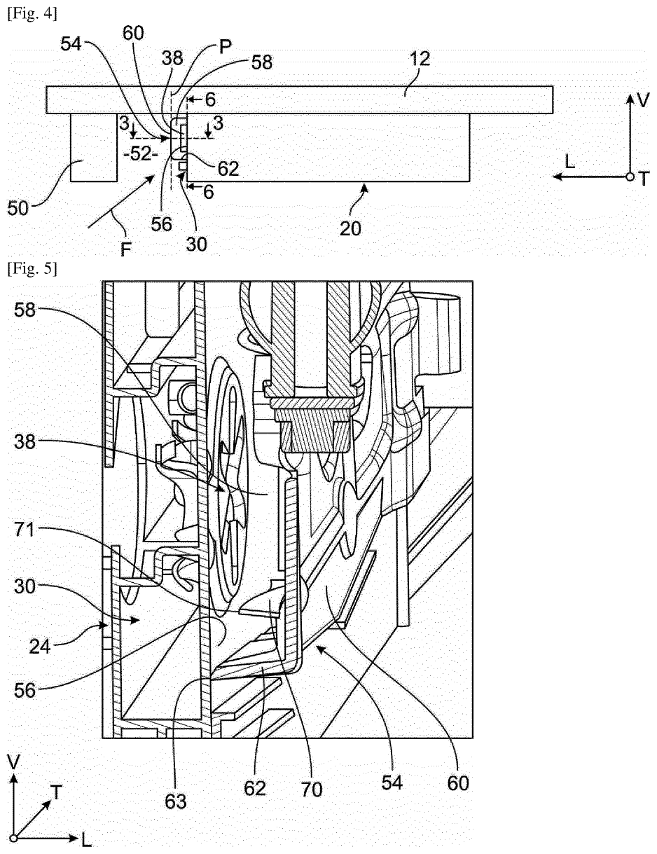

The cover 54 extends in a main plane “P” generally parallel to that of the vertical wall 30 in which each valve 38, 40 is arranged. The cover 54 has a concave shape so as to define a cavity 58 surrounding the valves 38, 40 by cooperation with the associated vertical wall 30, as illustrated in FIG. 5. In particular, this cavity 58 allows the valves 38, 40 to open without interference. It is also sufficient to allow fluid exchanges between the space 24 inside the tray 22 and the outside via the valves 38, 40.

The cover 54 comprises a main plate 60 which extends in the plane “P” generally parallel to the rear vertical wall 30. This plate 60 is arranged longitudinally at a distance from the valves 38, 40 to allow the cavity 58 to be delimited.

The cover 54 comprises at least one lower rim 62, a free transverse end edge 63 of which is in contact with the outer face 56 of the vertical wall 30 of the tray 22 below the valves 38, 40. The lower rim 62 extends in a generally horizontal plane, orthogonal to the vertical wall 30. The rim 62 extends, for example, from a generally horizontal lower edge of the main plate 60 towards the rear vertical wall 30.

The lower rim 62 is designed to intercept a water jet directed directly towards said at least one valve 38, 40 from the underside of the vehicle.

The cover 54 is not secured in a watertight manner to the rear vertical wall 30 of the tray 22 because it is necessary to allow fluid exchanges between the space 24 inside the tray 22 and the outside atmosphere. As a result, water is still likely to penetrate inside the cavity 58 delimited by the cover 54 and the vertical rear wall 30. To allow water to drain away by gravity to the outside of the cavity 58, the lower rim 62 comprises water discharge orifices 65, as is particularly visible in FIG. 6.

The discharge orifices 65 are formed here by notches made in the free end edge of the lower rim 62.

The cover 54 may also comprise an upper rim 64 and lateral rims 66. However, these rims are only present in the areas where a high-pressure jet of water emitted from the underside of the vehicle can reach the valves 38, 40 via the top or sides of the cover 54 arranged on the tray 22.

Although the presence of the lower rim 62 and the main plate 60 of the cover 54 drastically reduces the risk of hitting a valve 38, 40 directly with a high-pressure water jet, there is still a risk of the water jet penetrating directly into the cavity 58 by passing through the water discharge orifices 65.

To complete the protection of the valves 38, 40, the cover 54 comprises an inner face 68 equipped with at least one deflector 70 which is interposed between the discharge orifices 65 and said at least one valve 38, 40. The deflector 70 is designed to intercept any water jet passing through a discharge orifice 65 and directed towards said at least one valve 38, 40. To this end, said at least one deflector 70 is interposed between the discharge orifices 65 and each of the two valves 38, 40.

Here the cover 54 comprises a single deflector 70 which simultaneously protects both valves 38, 40. The deflector 70 is interposed between the discharge orifices 65 and each of the two valves 38, 40.

More particularly, the deflector 70 extends here from an inner face 68 of the main plate 60 of the cover 54 towards the rear vertical wall 30. A transverse edge 71 at the free end of the deflector 70 is substantially in contact with the rear vertical wall 30.

The deflector 70 extends parallel to and above the lower rim 62.

The cover 54 is made of a rigid plastic material.

The cover 54 is preferably made in one piece. The cover 54 is made in one piece by moulding, for example.

The deflector 70 is formed here by a rib which extends from the inner face 68 of the cover 54 towards the rear vertical wall 30 of the tray 22.

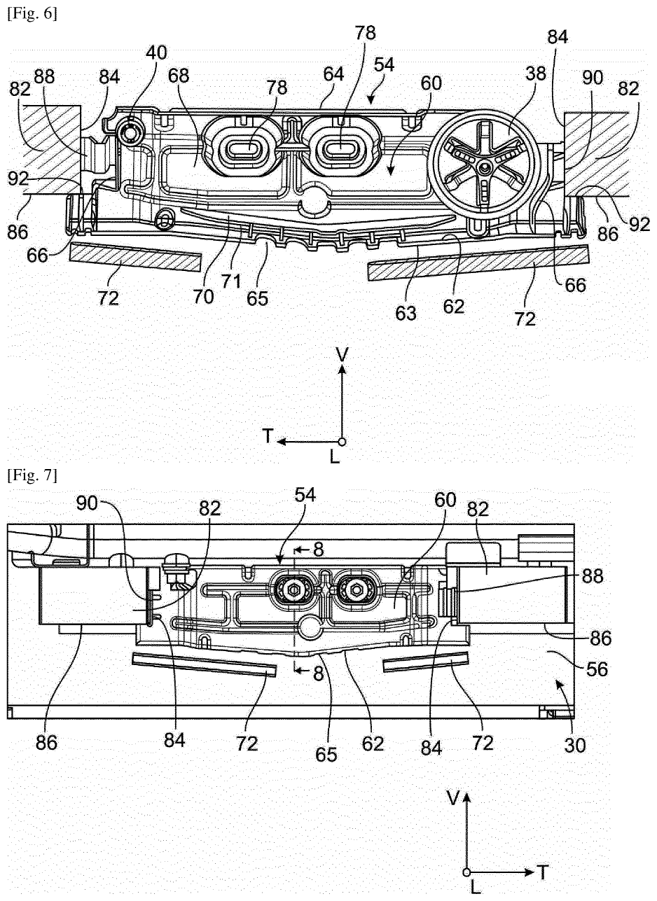

To prevent the water jet from entering through unsealed gaps between the free edge 63 of the lower rim 62 of the cover 54 and the vertical rear wall 30, two transverse protective strips 72 are welded to the vertical rear wall 30 below each valve 38, 40 and below the cover 54 at a vertical distance. The two protective bars 72 are transversely spaced from each other. The transverse gap between the two bars 72 extends substantially in line with the discharge orifices 65, as shown in FIGS. 6 and 7.

The cover 54 can be secured to the rear vertical wall 30 in any known way, for example by screwing, gluing, elastic interlocking, etc.

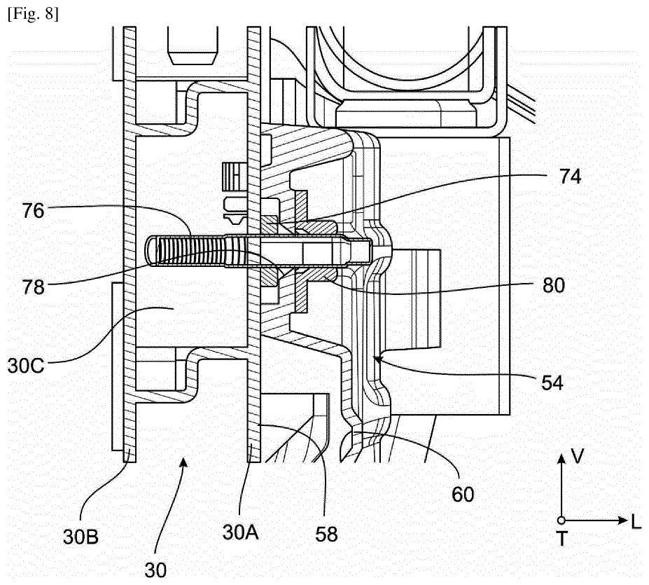

In the embodiment shown in FIG. 8, the cover 54 is screwed to the vertical rear wall 30.

The vertical wall 30 is formed by an outer envelope 30A comprising the outer face 58 and an inner partition 30B parallel to the outer envelope 30A. The inner partition 30B and the outer envelope 30A are separated by an air gap 30C. Two secured nuts 74 are secured in an associated hole in the outer envelope 30A. A threaded rod 76 is screwed into each secured nut 74, penetrating the air gap 30C but without passing through the inner partition 30B. The cover 54 comprises holes 78 through which each threaded rod 76 passes. The through holes 78 are arranged vertically at the same level, between the two valves 38, 40. A loose nut 80 is then screwed to each threaded rod 76 to clamp the cover 54 between the secured nuts 74 and the loose nuts 80. To make it easier to insert the threaded rods 76 into the through holes 78, they are surrounded by a chamfer on the inner face 68 of the cover 54.

As shown in FIG. 7, the valves 38, 40 are generally arranged between two protuberances 82 which extend longitudinally and project from the outer face 58 of the rear vertical wall 30. Each protuberance 82 is shaped like a parallelepiped. Each protuberance 82 thus has a longitudinal vertical bearing face 84 which faces the other protuberance 82. The two bearing faces 84 thus face each other transversely on either side of the cover 54. In addition, each protuberance comprise a lower horizontal face 86.

To facilitate mounting of the cover 54 on the rear vertical wall 30 of the tray 22, the cover 54 comprises at one of its transverse ends a resiliently flexible tab 88 which is intended to be resiliently clamped against a bearing face 84, while an opposite rigid transverse end 90 of the cover 54 bears against the opposite bearing face 84. The clamping of the cover 54 between the two bearing faces 84 by elastic deformation of the elastic tab 88 allows the cover 54 to be held in position while an operator secures the cover 54 to the rear vertical wall 30. In addition, the resilient tab 88 allows the cover 54 to be automatically centred between the two protrusions 82 in a transverse direction.

To make it easier to position the cover 54 vertically, it comprises two positioning faces 92 which are intended to abut vertically upwards against the lower face 86 of each protuberance 82.

During mounting, the cover 54 is positioned between the two protrusions 82, at a distance from the rear vertical wall 30. Then, the cover 54 is positioned so that the positioning faces 92 are in abutment against the lower faces 86 of the protrusions 82. The cover 54 is then moved longitudinally forwards so that the threaded rods 76 penetrate the associated holes 78 in the cover 54. The holes 78 have an elongated oblong shape in the transverse direction to enable the elastic tab 88 to center the cover 54 transversely between the two protuberances 82. The cover 54 is then secured by screwing on the loose nuts 80.

Advantageously, the cover 54 can be mounted on or dismounted from the vertical wall 30 of the tray 22 when the traction battery 20 is mounted on the chassis 12, to facilitate the operator's work.

The cover 54 thus positioned advantageously prevents a high-pressure water jet from directly reaching the valves 38, 40. This prevents accidental damage to the traction battery 20 when cleaning the vehicle.

1. A motor vehicle traction battery comprising:
a tray containing battery cells;
at least one valve arranged in a vertical wall of the tray;
a protective cover which is secured to an outer face (58) of said vertical wall (30),
covering said at least one valve;
wherein the cover comprises at least one lower rim a free end edge of which is in contact with the outer face of the vertical wall and which is intended to intercept a water jet directed towards at least one valve, the lower rim comprising water discharge orifices.

2. The traction battery according to claim 1, wherein the
cover comprises an inner face equipped with at least one deflector which is interposed between the discharge orifices and said at least one valve, the deflector being intended to intercept a water jet passing through the discharge orifices and directed towards said at least one valve.

3. The traction battery according to claim 2, wherein the deflector is formed by a rib which extends from the inner face of the cover in the direction of the vertical wall of the tray.

4. The traction battery according to claim 1, wherein said vertical wall comprises two valves said cover simultaneously covering both valves.

5. The traction battery according to claim 2, wherein said at least one deflector is interposed between the discharge orifices and each of the two valves.

6. The traction battery according to claim 1, wherein the cover is made of a plastic material.

7. The traction battery according to claim 6, wherein the cover is made in a single piece by moulding.

8. The traction battery according to claim 1, wherein the vertical wall is made of an outer envelope comprising the outer face and an inner partition separated by an air gap, the cover being secured to the vertical wall by means of a nut secured in the outer envelope and a threaded rod which penetrates into the air gap without passing through the inner partition.

9. The traction battery according to claim 1, wherein the vertical wall of the tray is equipped with two vertical bearing faces facing each other and projecting orthogonally with respect to the vertical wall, between which the cover is received, the cover comprising a resiliently flexible free end lug enabling the cover to be held between the two bearing faces by clamping.
